(19) United States
(12) Patent Application Publication
(10) Pub. No.: US 2011/0012829 A1
(43) Pub. Date: Jan. 20, 2011

(54) CURSOR CONTROL METHOD FOR CONTROLLING CURSOR DISPLAYED ON MONITOR OF ELECTONIC APPARATUS BY MEANS OF PRESSURE DETECTION AND CURSOR CONTROL DEVICE THEREOF

(75) Inventor: MAO-NAN YAO, Nanjing (CN)

Correspondence Address: WPAT, PC;INTELLECTUAL PROPERTY ATTORNEYS, 2030 MAIN STREET, SUITE 1300, IRVINE, CA, 92614, US

(73) Assignees: INVENTEC APPLIANCES CO. LTD., SHANGHAI, Shanghai City (CN); INVENTEC APPLIANCES CORP., TAIPEI COUNTY (TW); INVENTEC APPLIANCES CORP., NANJING, Nanjing (CN)

(21) Appl. No.: 12/832,085

(22) Filed: Jul. 8, 2010

(30) Foreign Application Priority Data
Jul. 17, 2009 (CN) 200910160794.7

(51) Int. Cl. G09G 5/08

(52) U.S. Cl. 345/157

(57) ABSTRACT

The present invention relates a cursor control method for controlling a cursor displayed on a monitor of an electronic apparatus by means of pressure detection and a cursor control device thereof. The cursor control device comprises a circuit substrate, a processing unit, a control panel and conductive elastic convex parts. The control panel is disposed above the circuit substrate, and a second surface is next to the circuit substrate. The conductive elastic convex parts are disposed on the second surface and corresponding to electrical contacts on the circuit substrate. When a point on the first surface receives an exerted pressure, the conductive elastic convex part is pressed against the circuit substrate and is deformed. The sensing module detects a change in electrical conductivity thereof according to the change in the electrical resistance. The processing unit calculates a position of the point for controlling the moving direction of the cursor.

### FIELD OF THE INVENTION

The present invention relates to a cursor control method and a cursor control device thereof; and more particularly, to a cursor control method for controlling a cursor displayed on a monitor of an electronic apparatus by means of pressure detection and a cursor control device thereof.

### BACKGROUND OF THE INVENTION

Currently, functions of communication equipments are gradually becoming complicated, some of which may even be regarded as a personal multimedia portable device. For coping with various kinds of functional operations, such as accessing internet, listening to music or taking pictures etc, the human-machine interfaces of the communication equipments are also complicated to become user-unfriendly.

For example, direction keys are usually used as a major operating device in known communication equipments. Conventional direction keys include two direction keys or four direction keys in order to provide users for controlling a cursor to move up, down, left and right on a screen. However, such a simple cursor moving mode does not meet the demands for the new generations of the human-machine interfaces.

Nowadays, more touch screens are utilized on communication device products to directly select patterns for users. Compared with the traditional liquid crystal screen, the touch screen procedure is complicated and has high costs.

For maintaining low costs as well as achieving the goal of fast and simple operation, the present invention discloses an omni-direction key to meet the demands for the human-machine interface on modern communication devices.

### SUMMARY OF THE INVENTION

The present invention is to provide a cursor control method for controlling a cursor on a monitor of an electric apparatus by means of pressure detection and a cursor control device thereof. A major object of the present invention is to modify direction keys of conventional communication devices, thereby simplifying complicate human-machine interfaces. The cursor control device of the present invention comprises at least three conductive elastic convex parts symmetrically disposed on a second surface of a control panel. When a point on the first surface receives an exerted pressure, at least one of the at least three conductive elastic convex parts receives a divided pressure to press against a circuit substrate. In the meanwhile, a change in electrical resistance of the at least one of the at least three conductive elastic convex parts is induced due to the exerted pressure, and then other electrical conductivities are changed. The cursor control device uses a sensing module to detect changed electrical conductivity, and to calculate the position of the point on the first surface so as to comprehensively control the moving direction of the cursor.

The cursor control device for controlling a cursor displayed on a monitor of an electronic apparatus by means of pressure detection of the present invention comprises a control panel, a circuit substrate, a processing unit and at least three conductive elastic convex parts. The circuit substrate comprises at least three electrical contacts. The control panel is disposed above the circuit substrate, and comprises a first surface and a second surface which is disposed between the first surface and the circuit substrate. The conductive elastic convex parts are made of electroconductive rubber, and separately disposed on the second surface and respectively corresponding to the electrical contacts on the circuit substrate.

The processing unit comprises a sensing module. The sensing module comprises a digital-to-analog voltage converter, a pressure conversion program and a direction calculation program, and electrically coupled to the electrical contacts respectively.

When a point on the first surface receives an exerted pressure, at least one of the at least three conductive elastic convex parts receives a divided pressure, and is pressed against the circuit substrate. The at least three conductive elastic convex parts are deformed to cause changes in electrical resistance thereof according to the exerted pressure, thereby changing electrical conductivities corresponding thereto.

The sensing module detects all changed electrical conductivities by means of the digital-to-analog voltage converter which converts digital information to electrical conductivity information. The pressure conversion program is used to generate divided pressure information according to the electrical conductivity information, thereby calculating the position of the point on the first surface from many divided pressures via the direction calculation program, thus controlling the moving direction of the cursor according to the position of the point.

In an embodiment, the cursor control device comprises four conductive elastic convex parts. The four conductive elastic convex parts are disposed on the second surface with rhombic symmetry. When a user presses the exerted pressure on the first surface, two of the conductive elastic convex parts are usually pressed against the circuit substrate.

Therefore, the direction keys of the conventional communication device only control a cursor to move up, down, left and right. Compared with the prior art, the cursor control method for controlling the cursor displayed on a monitor of an electronic apparatus by means of pressure detection and the cursor control device thereof can detect the position of the point on the control panel where users apply the exerted pressure through the changed electrical conductivity resulted from deforming the conductive elastic convex parts. Thus, the moving direction of the cursor can be controlled.

### BRIEF DESCRIPTION OF THE DRAWINGS

The structure and the technical means adopted by the present invention to achieve the above object can be best understood by referring to the following detailed description of the preferred embodiments and the accompanying drawings, wherein

FIG. 1 is a structure schematic diagram of parts of a cursor control device according to an embodiment of the present invention;

FIG. 1A is a schematic diagram of the cursor control device in operation according to the embodiment of the present invention;

FIG. 2 is a circuit path diagram of a circuit substrate according to an embodiment of the present invention;

FIG. 3 is a functioned block diagram of a cursor control device according to an embodiment of the present invention; and

FIG. 4 is a simple flowchart of a cursor control method by means of pressure detection according to an embodiment of the present invention.

### DETAILED DESCRIPTION OF THE PREFERRED EMBODIMENTS

The present invention will now be described with some preferred embodiments thereof with reference to the accompanying drawings. It is understood the experimental data shown in the embodiments are provided only for easy interpretation of the technical means of the present invention and should in no means be considered as restriction to the present invention.

In an embodiment of the present invention, a cursor control device for controlling a cursor displayed on a monitor of an electronic apparatus by means of pressure detection may be applied to a communication device, such as a cellular phone as a human-machine interface input device of simplified operation. The cursor control device comprises a control panel, a circuit substrate, a processing unit and four conductive elastic convex parts. Particularly, as few as three conductive elastic convex parts may achieve the goal of the present invention.

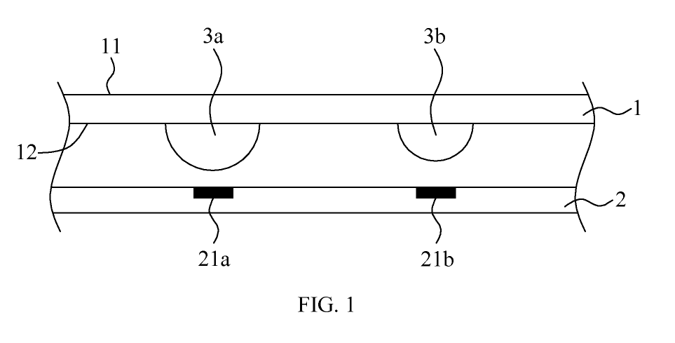

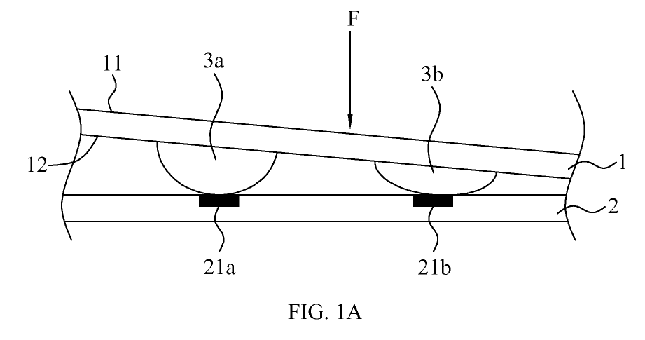

Detailed descriptions with the figures are shown as follows. Please refer to FIG. 1 that is a structure schematic diagram of parts of a cursor control device according to an embodiment of the present invention. The control panel 1 comprises a first surface 11 and a second surface 12 which is opposite to the first surface 11. The control panel 1 is disposed above a circuit substrate 2, and the second surface faces to the circuit substrate 2. The four conductive elastic convex parts 3a, 3b, 3c, 3d (3c and 3d not shown in the FIG. 1) are respectively disposed on the second surface 12. Wherein, the four conductive elastic convex parts 3a, 3b, 3c, 3d (3c and 3d not shown in the FIG. 1) are made of electroconductive rubber, and are not in contact with the circuit substrate 2 without applying pressure.

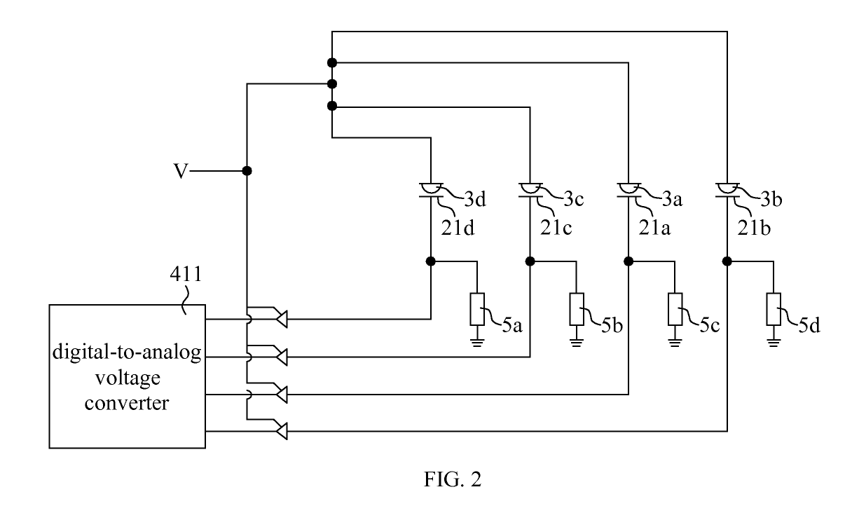

The circuit substrate 2 comprises a circuit path. Please refer to FIG. 2, which is a circuit path diagram of a circuit substrate according to an embodiment of the present invention. As shown, the circuit path is formed by four branch circuit paths connected with each other in parallel, and the four branch circuit paths are respectively connected with the reference resistors 5a, 5b, 5c, 5d which have different resistance values. The branch circuit paths further comprise electrical contacts 21a, 21b, 21c, 21d corresponding to the four conductive elastic convex parts 3a, 3b, 3c, 3d, respectively. When the electrical contacts are electrically connected to the conductive elastic convex parts with each other, the branch circuit paths are conducted.

The four branch circuit paths are electrically connected to a digital-to-analog voltage converter 411 arranged for measuring the divided voltage of the reference resistors 5a, 5b, 5c, 5c of the branch circuit paths while conducting the branch circuit paths.

Wherein, as shown in FIG. 2, the four conductive elastic convex parts 3a, 3b, 3c, 3d are disposed on the control panel 1 with rhombic symmetry. Additionally, the cursor control device of the present invention comprises three conductive elastic convex parts 3a, 3b, 3c, and the three conductive elastic convex parts 3a, 3b, 3c are disposed on the control panel 1 with equilateral triangle symmetry. Thus, when a user applies pressure F to the conductive elastic convex parts 3a, 3b, 3c disposed on the control panel 1, the conductive elastic convex parts 3a, 3b, 3c receive more uniformly divided pressure, so as to subsequently avail of the calculation of the sum of the divided pressures.

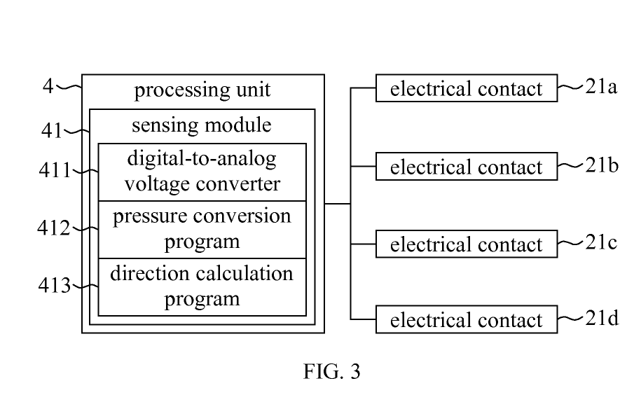

Please refer to FIG. 3, which is a functioned block diagram of a cursor control device according to an embodiment of the present invention. As shown, the processing unit 4 comprises a sensing module 41, and the sensing module 41 comprises a digital-to-analog voltage converter 411, a pressure conversion program 412 and a direction calculation program 413.

The processing unit 4 may be a processor or a control board comprising electrical units relating to the processor. The sensing module 41 may be a firmware with computer codes, and is electrically coupled to the electrical contacts 21a, 21b, 21c, 21d, respectively. While the conductive elastic convex part 3a is electrically connected to the electrical contact 21a and therefore forms a conductive path on the branch circuit paths, all changed electrical conductivities are detected and converted to digital information by the digital-to-analog converter 411 to obtain electrical conductivity information. A direction of the pressure F supplied to the control panel 1 is calculated via the electrical conductivity information through the pressure conversion program 412 and the direction calculation program 413.

Please refer back to FIG. 1. As shown, the conductive elastic convex parts 3a, 3b are disposed on the control panel 1 corresponding to the second surface 12 of the first surface 11 and corresponding to the electrical contacts 21a, 21b of the circuit substrate 2.

Subsequently, please refer to FIG. 1A and FIG. 2. FIG. 1A is a motion schematic diagram of the cursor control device according to the embodiment of the present invention. As shown in FIG. 1A, when the pressure F is applied to the first surface 11, the control panel 1 is pressed against the conductive elastic convex parts 3a, 3b which respectively receive a divided pressure and then supplying to the circuit substrate 2. In the meanwhile, the conductive elastic convex parts 3a, 3b are electrically connected to the electrical contacts 21a, 21b to conduct the two branch circuit paths.

The conductive elastic convex parts 3a, 3b are deformed depending on the strength of the divided pressure, thereby altering contacted areas of the electrical contacts 21a, 21b electrically connected thereto. The larger the contacted area, the smaller the resistance values obtained through the conductive elastic convex parts 3a, 3b corresponding the branch circuit paths, and therefore, the electrical conductivities thereof are also changed, such as the divided voltage. Because of the deformation property, the conductive elastic convex part 3a, 3b may be regarded as variable resistances.

Please refer to FIG. 2 and FIG. 3. In an embodiment of the present invention, the digital-to-analog voltage converter 411 detects the divided pressure of the reference resistor 5a on the branch circuit paths, thereby converting to the digital information, thereby producing the electrical conductivity information. According to Kirchhoff's Voltage Law (KVL), when the branch circuit paths have two electrical resistances, the sum of the divided voltage of the electrical resistances means the total voltage. Therefore, the divided voltage ratio of the reference resistor 5a and the conductive elastic convex part 3a is calculated by calculating the divided voltage of the conductive elastic convex part 3a on the branch circuit paths which is converted with the reference of the divided voltage of the reference resistor 5a.

According to the series circuit principle, the divided voltage and the resistance value are in direct proportion. Thus, the divided voltage ratio of the conductive elastic convex part 3a and the reference resistor 5a is the resistance value ratio of the conductive elastic convex part 3a and the reference resistor 5a. The resistance value of the reference resistor 5a is a known constant, thereby the resistance value of the conductive elastic convex part 3a may be obtained while receiving the divided pressure.

The divided pressure of the conductive elastic convex part 3a is calculated by the pressure conversion program 412 from the transformation function of the resistance value of the conductive elastic convex part 3a according to the known resistance characteristic table. Further, the direction calculation program 413 calculates the included angle of the divided pressure vectors of the conductive elastic convex part 3a, 3b by means of the trigonometric function, so as to calculate the position on the first surface 11 where the pressure F is applied. Thus, the moving directions of the cursor corresponding to the position can be controlled accordingly.

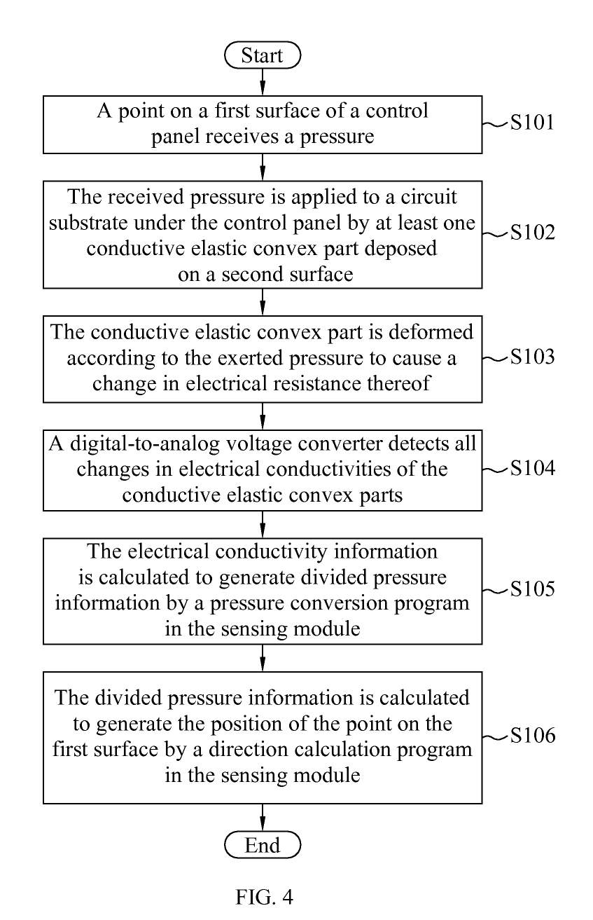

Please refer to FIG. 4, that is a simplified flowchart of a cursor control method by means of pressure detection according to an embodiment of the present invention. As shown, the cursor control method for controlling a cursor displayed on a monitor of an electronic apparatus by means of pressure detection comprises the steps as the following. In the step 101, a point on a first surface 11 of a control panel 1 receives a pressure F. In the step 102, the received pressure is applied to a circuit substrate 2 under the control panel 1 by at least one of conductive elastic convex part 3a, 3b, 3c, 3d disposed on a second surface 12 opposite to the first surface 11 of the control panel 1.

Meanwhile, the conductive elastic convex part 3a is deformed according to the received pressure to cause a change in electrical resistance thereof (step 103). In a sensing module 41, a digital-to-analog voltage converter 411 detects all changes in electrical conductivities of the conductive elastic convex parts according to the change in the electrical resistance (step 104). The electrical conductivity information is calculated to generate divided pressure information by a pressure conversion program 412 in the sensing module 41 (step 105). In the step 106, the divided pressure information is calculated to generate the position of the point on the first surface 11 where the pressure F is applied by a direction calculation program 413 in the sensing module 41.

In summary, the cursor control device of the present invention has the three conductive elastic convex parts 3a, 3b, 3c, and in an embodiment of the present invention, there are four conductive elastic convex parts 3a, 3b, 3c, 3d symmetrically disposed on the second surface 12 of the control panel 1. When the pressure F is pressed on the first surface 11 of the control panel 1, two of the conductive elastic convex part 3a, 3b, 3c, 3d receive a divided pressure to press against the circuit substrate 2.

Meanwhile, the conductive elastic convex parts 3a, 3b are deformed according to the received pressure, subsequently thereby changing other electrical conductivities, such as the divided pressure. The changed divided pressure, which is detected by the digital-to-analog voltage converter 411 of the sensing module 41, is converted to the digital information. The electrical conductivity information generated by the digital-to-analog voltage converter 411 is calculated to generate the divided pressure information by the pressure conversion program 412, thereby calculating the position of the point on the first surface 11 by the direction calculation program 413, such that the moving direction of the cursor may be controlled accordingly.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A cursor control device for controlling a cursor displayed on a monitor of an electronic apparatus by means of pressure detection, comprising:
a circuit substrate comprising at least three electrical contacts;
a processing unit comprising a sensing module electrically coupled to the at least three electrical contacts;
a control panel disposed above the circuit substrate and comprising a first surface and a second surface disposed between the first surface and the circuit substrate; and
at least three conductive elastic convex parts respectively disposed on the second surface and corresponding to the at least three electrical contacts;
wherein, when a point on the first surface receives an exerted pressure, at least one of the at least three conductive elastic convex parts is pressed against the circuit substrate, and is deformed to cause a change in electrical resistance of the at least one of the at least three conductive elastic convex parts according to the exerted pressure; the sensing module is used to detect a change in electrical conductivity of the at least one of the at least three conductive elastic convex parts according to the change in the electrical resistance, and the processing unit is used to calculate a position of the point according to the change in the electrical conductivity for controlling a moving direction of the cursor.

2. The cursor control device as claimed in claim 1, comprising four of the conductive elastic convex parts being symmetrically disposed.

3. The cursor control device as claimed in claim 1, wherein the at least three conductive elastic convex parts are made of electroconductive rubber.

4. The cursor control device as claimed in claim 1, wherein the sensing module further comprises a digital-to-analog voltage converter arranged for measuring a voltage of each of the elastic convex parts, whose electrical conductivity is changed due to the exerted pressure, in order to generate electrical conductivity information of each of the conductive elastic convex parts.

5. The cursor control device as claimed in claim 4, wherein the processing unit uses a pressure conversion program and a direction calculation program, the pressure conversion program is used to convert the electrical conductivity information to divided pressure information on each of the conductive elastic convex parts, and the direction calculation program is used to calculate the position of the point on the first surface according to the divided pressure information.

6. A cursor control method for controlling a cursor displayed on a monitor of an electronic apparatus by means of pressure detection, comprising the following steps:
(a) exerting a pressure at a point on a first surface of a control panel;
(b) applying the exerted pressure to cause at least one conductive elastic convex part disposed on a second surface of the control panel to be pressed against a circuit substrate, wherein the second surface is disposed between the first surface and the circuit substrate;
(c) deforming the at least one conductive elastic convex part to cause a change in electrical resistance of the at least one conductive elastic convex part according to the exerted pressure;
(d) detecting a change in electrical conductivity of the at least one conductive elastic convex part according to the change in the electrical resistance; and
(e) calculating a position of the point according to the change in the electrical conductivity for controlling a moving direction of the cursor.

7. The cursor control method as claimed in claim 6, wherein the step (d) comprises a step (d0) of measuring a voltage of the at least one conductive elastic convex part, in order to generate electrical conductivity information of the at least one conductive elastic convex part.

8. The cursor control method as claimed in claim 7, wherein the step (e) comprises a step (e0) of converting the electrical conductivity information to divided pressure information on the at least one conductive elastic convex part.

9. The cursor control method as claimed in claim 8, wherein the step (e) comprises a step (e1) of calculating the position of the point on the first surface according to the divided pressure information.
